(19) United States
(12) Patent Application Publication
(10) Pub. No.: US 2022/0209451 A1
(43) Pub. Date: Jun. 30, 2022

(54) CONNECTOR FIXING STRUCTURE

(71) Applicant: TOYOTA JIDOSHA KABUSHIKI KAISHA, Toyota-shi (JP)

(72) Inventor: Taisuke WARASHINA, Toyota-shi (JP)

(73) Assignee: TOYOTA JIDOSHA KABUSHIKI KAISHA, Toyota-shi (JP)

(21) Appl. No.: 17/514,317

(22) Filed: Oct. 29, 2021

(30) Foreign Application Priority Data
Dec. 25, 2020 (JP) 2020-217179

(51) Int. Cl. H01R 13/434; H01R 13/436

(52) U.S. Cl. CPC H01R 13/434; H01R 13/4362

(57) ABSTRACT

A connector fixing structure includes: a device case including a wall portion in which an attachment hole is provided; and a connector including a housing fixed to the device case, the housing including an insertion portion inserted in the attachment hole, and a shell covering the housing from the outer side. At a part of the wall portion, the part being located around the attachment hole, a projection portion that projects toward one side in an axis direction of the attachment hole from the wall portion is provided. The projection portion includes a lateral portion on one end side in a lateral direction orthogonal to the axis direction. The shell includes a lateral cover portion that covers the lateral portion.

### CROSS-REFERENCE TO RELATED APPLICATION

This application claims priority to Japanese Patent Application No. 2020-217179 filed on Dec. 25, 2020, incorporated herein by reference in its entirety.

### BACKGROUND

### 1. Technical Field

The present disclosure relates to a connector fixing structure mounted in a vehicle.

### 2. Description of Related Art

Conventionally, Japanese Unexamined Patent Application Publication No. 2015-82464 (JP 2015-82464 A) discloses a fixing structure in which a connector is fixed to a device case mounted in a vehicle by inserting an insertion portion of the connector to a cylindrical portion provided at the device case. The connector includes a housing including the insertion portion to be inserted to the inside of the cylindrical portion, and a shielding shell covering the housing.

### SUMMARY

However, the shielding shell described in JP 2015-82464 A includes an upper wall portion that covers the upper side of the cylindrical portion and that is fastened to an upper portion of the cylindrical portion but includes no side wall portions that cover lateral sides of the cylindrical portion.

In general, when a connector is inserted to a device case mounted in a vehicle, a worker may be unable to come around to the front side of the cylindrical portion depending on the positional relationship with surrounding structural objects.

In such situation, when the upper wall portion of the shielding shell described in JP 2015-82464 A is made to butt the cylindrical portion to assemble the connector to the device case, a position of the connector in a left-right direction of the vehicle may fail to be determined. Therefore, there are cases where the connector cannot easily be assembled to the device case.

In addition, in the connector fixing structure in JP 2015-82464 A, the lateral sides of the cylindrical portion are exposed to the outside, and thus, there is room for improvement for curbing entry of foreign matter into the cylindrical portion.

The present disclosure has been made in view of the above problems, and an object of the present disclosure is to provide a connector fixing structure that enables enhancement in assemblability with a simple configuration and that enables curbing entry of foreign matter from the outside to an attachment hole.

A connector fixing structure according to the present disclosure includes: a device case including a wall portion in which an attachment hole is provided; and a connector including a housing fixed to the device case, the housing including an insertion portion inserted in the attachment hole, and a shell covering the housing from the outer side. At a part of the wall portion, the part being located around the attachment hole, a projection portion that projects toward one side in an axis direction of the attachment hole from the wall portion is provided. The projection portion includes a lateral portion on one end side in a lateral direction orthogonal to the axis direction. The shell includes a lateral cover portion that covers the lateral portion.

In the above configuration, because of the shell included in the connector including the lateral cover portion, when the insertion portion of the connector is inserted to the attachment hole provided in the device case, a position of the connector can easily be grasped by bringing an inner surface of the lateral cover portion into abutment with the projection portion provided in the part of the wall portion, the part being located around the attachment hole. As a result of the position of the connector being grasped, even where the attachment hole cannot be viewed from the front side in relation to surrounding structural objects, the insertion portion can easily be inserted to the attachment hole. As a result, enhancement of capability of assembling of the connector to the device case can be enabled with such simple configuration. Also, the lateral portion of the projection portion being covered by the lateral cover portion enables curbing entry of foreign matter into the shell from the outside in comparison with a case where the lateral portion is exposed.

In the connector fixing structure according to the present disclosure, the shell may include a body portion including a back-side wall portion located on the one side in the axis direction, an upper wall portion connected to the back-side wall portion on an upper side in a height direction orthogonal to the axis direction and the lateral direction, and a side wall portion connected to the upper wall portion and the back-side wall portion. In this case, the lateral cover portion may be provided in such a manner as to project outward in the lateral direction from the side wall portion, and the lateral cover portion and the body portion may be integrally configured using the same member.

In the above configuration, by the body portion of the shell and the lateral cover portion being integrally configured using the same member, the configuration of the shell can be simplified in comparison with a case where the body portion and the lateral cover portion are configured separately.

In the connector fixing structure according to the present disclosure, a labyrinth structure may be formed between the lateral portion and the lateral cover portion.

The above configuration enables further curbing entry of foreign matter into the lateral cover portion from the outside via the labyrinth structure.

In the connector fixing structure according to the present disclosure, the lateral cover portion may include a blocking member that blocks electromagnetic waves or an absorbent member that absorbs electromagnetic waves.

The above configuration enables reduction of an effect of electromagnetic wave noise by the lateral cover portion.

In the connector fixing structure according to the present disclosure, a gap may be formed between a part of the shell, the part being located below the lateral cover portion in the height direction orthogonal to the axis direction and the lateral direction, and the device case.

With the above configuration, even if foreign matter such as liquid enters the shell, the foreign matter can be discharged from the gap between the lower side of the shell and the device case. Accordingly, it is possible to curb accumulation of liquid inside the shell and thus it is possible to curb corrosion of the shell and structural objects inside the shell.

In the connector fixing structure according to the present disclosure, the lateral cover portion may be at least partly fitted on the lateral portion. In this case, a part of the shell, the part being located below the lateral cover portion in the height direction orthogonal to the axis direction and the lateral direction, may not be fitted on the device case.

In the above configuration, when the insertion portion of the connector is inserted to the attachment hole provided in the device case, the lateral cover portion is at least partly fitted on the lateral portion, enabling further enhancement in assemblability. In addition, because of the lower side of the shell being not fitted on the wall portion, a gap can be formed between the lower side of the shell and the wall portion. Consequently, foreign matter can be discharged from the gap. Even if foreign matter such as liquid enters the shell, the foreign matter can be discharged from the gap between the lower side of the shell and the wall portion. As a result, it is possible to curb accumulation of liquid inside the shell and thus it is possible to curb corrosion of the shell and the structural objects inside the shell.

In the connector fixing structure according to the present disclosure, the lateral cover portion may include a top portion at an upper portion in the height direction orthogonal to the axis direction and the lateral direction. Also, the top portion may include an inclined portion inclined downward toward the outer side in the lateral direction.

With the above configuration, the inclined portion being provided at the top portion of the lateral cover portion enables curbing accumulation of foreign matter such as liquid on the top portion. Consequently, it is possible to curb corrosion of the lateral cover portion.

In the connector fixing structure according to the present disclosure, the projection portion may include an end surface on the one side in the axis direction. In this case, a leaf spring may be connected to the shell. Also, the leaf spring may be in contact with the end surface of the projection portion.

The above configuration enables the leaf spring connected to the shell to be grounded to the wall portion via the projection portion. Consequently, an effect of electromagnetic wave noise can be reduced.

In the connector fixing structure according to the present disclosure, the axis direction may be parallel to a front-rear direction of a vehicle. Also, the device case may be disposed on the front side of the vehicle relative to the connector. In this case, the insertion portion may be inserted to the attachment hole from the rear side of the vehicle.

The above configuration favorably enables enhancement in assemblability in a case where the device case is disposed on the front side of the vehicle relative to the connector and a worker located on the front side of the device case attaches the connector to the device case.

The present disclosure enables provision of a connector fixing structure that enables enhancement in assemblability with a simple configuration and that enables curbing entry of foreign matter from the outside to an attachment hole.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a perspective view illustrating a connector fixing structure according to an embodiment in an assembled state in which a connector is assembled to a device case;

FIG. 2 is a perspective view of the device case according to the embodiment;

FIG. 3 is a perspective view of the connector according to the embodiment;

FIG. 4 is a sectional view along line IV-IV indicated in FIG. 1; and

FIG. 5 is a diagram of the assembled state illustrated in FIG. 1 as viewed from a lateral side.

### DETAILED DESCRIPTION OF EMBODIMENTS

An embodiment of the present disclosure will be described in detail below with reference to the drawings. In the below-described embodiment, parts that are identical or common to each other are provided with the same sign in the drawings and description thereof will not be repeated.

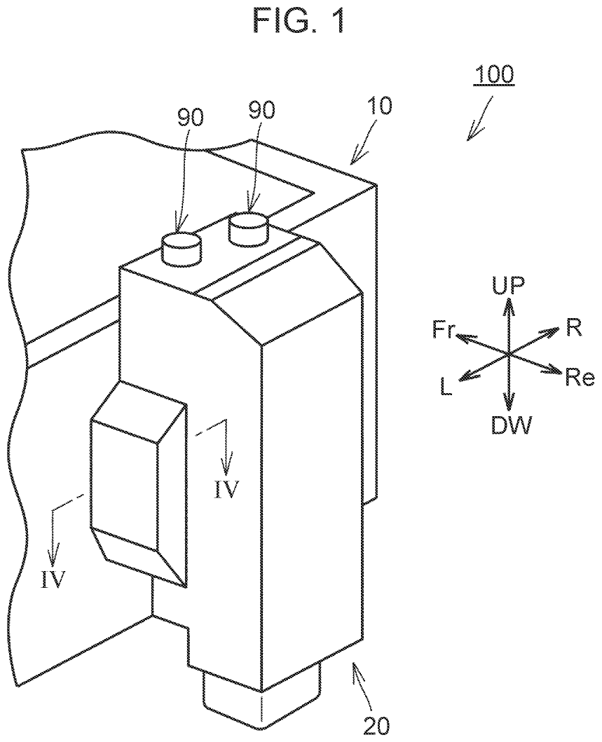

FIG. 1 is a perspective view illustrating a connector fixing structure according to the embodiment in an assembled state in which a connector is assembled to a device case. A connector fixing structure 100 according to the embodiment will be described with reference to FIG. 1.

As illustrated in FIG. 1, the connector fixing structure 100 according to the embodiment includes a device case 10 and a connector 20. The device case 10 is disposed on the front side of a vehicle relative to the connector 20. The connector 20 is fixed to the device case 10 via, e.g., fastening members 90.

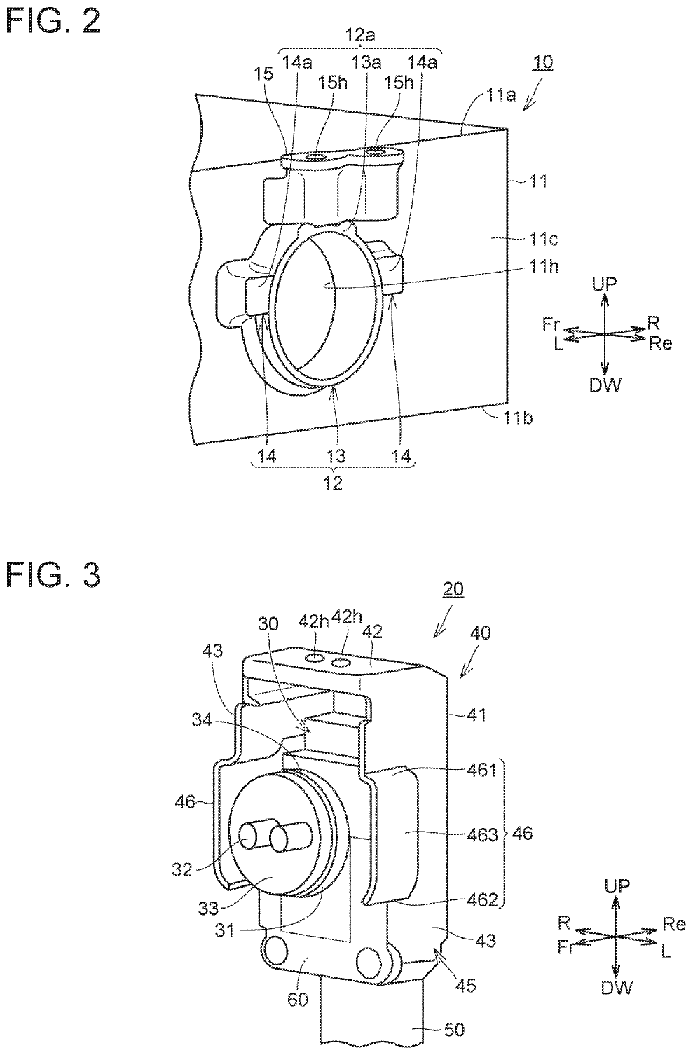

FIG. 2 is a perspective view of the device case according to the embodiment. The device case 10 will be described with reference to FIG. 2.

The device case 10 is a case mounted in the vehicle, for example, a case for, e.g., an inverter or a motor. Inside the device case 10, a device-side connector is disposed. The device case 10 is configured by, for example, a metal material having electrical conductivity.

The device case 10 has a substantially box-like shape. The device case 10 includes a wall portion 11 with an attachment hole 11h provided therein, and a projection portion 12 provided at the wall portion 11. The attachment hole 11h is provided in such a manner as to extend through the wall portion 11. An axis direction of the attachment hole 11h is substantially parallel to a front-rear direction of the vehicle.

The wall portion 11 includes an upper end 11a, a lower end 11b, and a wall surface 11c. The upper end 11a and the lower end 11b are located at opposite ends of the wall portion 11 in a height direction of the vehicle. A non-illustrated lid portion is fixed to the upper end 11a. Also, a lower case configuring the lower side of the device case 10 is fixed to the lower end 11b. The wall surface 11c faces toward the connector 20 side. More specifically, the wall surface 11c faces toward the rear side of the vehicle.

At a part of the wall portion 11, the part being located around the attachment hole 11h, the projection portion 12 that projects toward one side in the axis direction of the attachment hole 11h from the wall portion 11 (more specifically, the wall surface 11c) is provided.

The projection portion 12 includes a cylindrical portion 13 and a pair of bulge portions 14. The cylindrical portion 13 includes an inner circumferential surface defining the attachment hole 11h. The cylindrical portion 13 is disposed between the pair of bulge portions 14 in a lateral direction orthogonal to the axis direction. The lateral direction is substantially parallel to a left-right direction of the vehicle.

The pair of bulge portions 14 are aligned in the lateral direction. The pair of bulge portions 14 are located outside the cylindrical portion 13 in the lateral direction. One of the pair of bulge portions 14 corresponds to a lateral portion provided on one end side, in the lateral direction, of the projection portion 12.

The projection portion 12 includes an end surface 12a on one side in the axis direction. The end surface 12a includes an end surface 13a of the cylindrical portion 13 and respective end surfaces 14a of the pair of bulge portions 14.

An attached portion 15 is provided on the upper side of the wall portion 11, more specifically, above the cylindrical portion 13. Fastening grooves 15h are provided in an upper surface of the attached portion 15. The fastening grooves 15h are formed to allow the fastening members 90 to be fastened thereto.

FIG. 3 is a perspective view of the connector according to the embodiment. As illustrated in FIG. 3, the connector 20 includes a housing 30, a shell 40, a wiring lead-out portion 50, and a leaf spring 60.

The housing 30 is formed by, for example, a synthetic resin and has a substantially L-shape overall. One end of the housing 30 projects toward the front side of the vehicle and the other end of the housing 30 projects downward.

An insertion portion 31 to be inserted to the attachment hole 11h is provided at the one end of the housing 30. The insertion portion 31 has a substantially cylindrical shape. On the inner side of the insertion portion 31, terminal receiving portions 32 that each receive a connection terminal are provided. A retainer 33 is attached to the insertion portion 31 in such a manner that the terminal receiving portions 32 are exposed. The retainer 33 prevents the terminal receiving portions 32 from coming off to the front side of the vehicle. The connection terminals received in the terminal receiving portions 32 are connected to the aforementioned device-side connector when the insertion portion 31 is inserted to the attachment hole 11h.

A sealing ring 34 is fitted on an outer circumferential surface of the insertion portion 31. The sealing ring 34 is held between the attachment hole 11h and the outer circumferential surface of the insertion portion 31 when the insertion portion 31 is inserted to the attachment hole 11h. Consequently, a gap between the attachment hole 11h and the outer circumferential surface of the insertion portion 31 is sealed.

A wiring lead-out portion 50 is provided at the other end of the housing 30. Wiring is led out from the wiring lead-out portion 50.

The shell 40 covers the housing 30 from the outer side. The shell 40 is fixed to the housing 30 via, e.g., fastening members in a state in which the shell 40 covers the housing 30. The shell 40 is configured by, for example, a blocking member that blocks electromagnetic waves or an absorbent member that absorbs electromagnetic waves.

The shell 40 includes a body portion 45 including a back-side wall portion 41, an upper wall portion 42, and a pair of side wall portions 43, and a pair of lateral cover portions 46.

The back-side wall portion 41 is located on the one side in the axis direction. The back-side wall portion 41 has a plate-like shape and extends in the height direction. The upper wall portion 42 is connected to the back-side wall portion 41 on the upper side. The upper wall portion 42 extends in a direction parallel to the axis direction.

Through-holes 42h are provided at respective positions corresponding to the fastening grooves 15h, in the upper wall portion 42. The shell 40 is fixed to the device case 10 by disposing the upper wall portion 42 on the upper surface of the attached portion 15 in such a manner that the through-holes 42h and the fastening grooves 15h come into communication with each other, respectively, and fastening the fastening members 90 to the fastening grooves 15h.

The pair of side wall portions 43 connect the upper wall portion 42 and the back-side wall portion 41 on opposite sides in the lateral direction. The pair of side wall portions 43 each have a plate-like shape and extend in the height direction.

The pair of lateral cover portions 46 are provided at the pair of side wall portions 43, respectively. Each lateral cover portion 46 is provided in such a manner as to project outward in the lateral direction from the relevant side wall portion 43. The pair of lateral cover portions 46 are provided in such a manner as to be capable of covering lateral portions of the projection portion 12 from the outside in the lateral direction.

The pair of lateral cover portions 46 may be configured integrally with the body portion 45 using the same member. In this case, the configuration of the shell can be simplified in comparison with a case where a body portion and lateral cover portions are configured separately.

Also, the pair of lateral cover portions 46 may be each configured by a blocking member that blocks electromagnetic waves or an absorbent member that absorbs electromagnetic waves. In this case, in a state in which the connector 20 is assembled to the device case 10, an effect of electromagnetic wave noise can be reduced.

Each lateral cover portion 46 includes a top portion 461, a bottom wall portion 462, and a connecting wall portion 463. The top portion 461 is provided at an upper portion of the lateral cover portion 46. The top portion 461 includes an inclined portion inclined downward toward the outer side in the lateral direction. Consequently, it is possible to curb accumulation of foreign matter such as liquid on the top portion 461 and thus it is possible to curb corrosion of the lateral cover portion 46.

The bottom wall portion 462 is provided at a lower portion of the lateral cover portion 46. The bottom wall portion 462 is provided in such a manner as to extend inward in the lateral direction toward the lower side.

The connecting wall portion 463 is provided in such a manner as to connect the top portion 461 and the bottom wall portion 462. The connecting wall portion 463 has a plate-like shape and is provided in such a manner as to extend in the height direction.

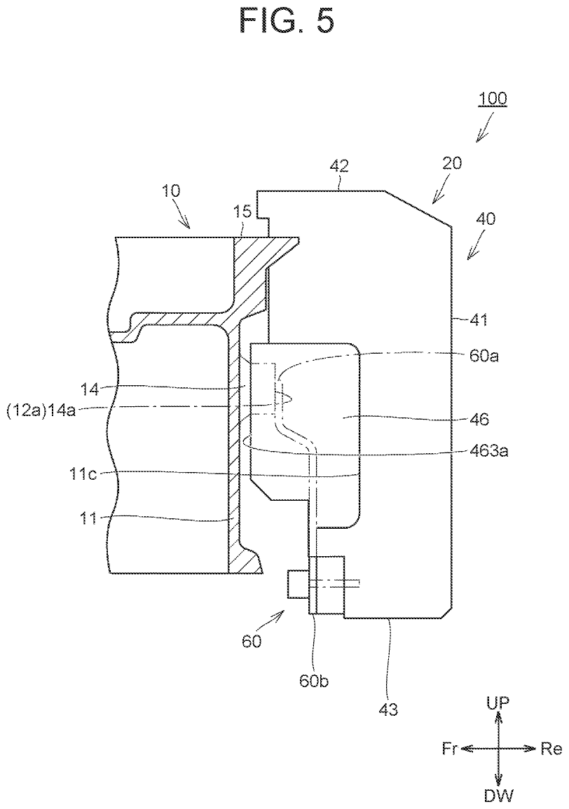

The leaf spring 60 includes an upper end 60a (see FIG. 5) and a lower end 60b (see FIG. 5). The leaf spring 60 is provided in such a manner that the upper end 60a side is closer to the wall portion 11 than the lower end 60b side is. The leaf spring 60 has a substantially S-shape.

The leaf spring 60 is connected to the shell 40. More specifically, the lower end 60b side of the leaf spring 60 is fixed to the shell 40 via fastening members. Consequently, the lower end 60b side of the leaf spring 60 is a fixed end and the upper end 60a side of the leaf spring 60 is a free end.

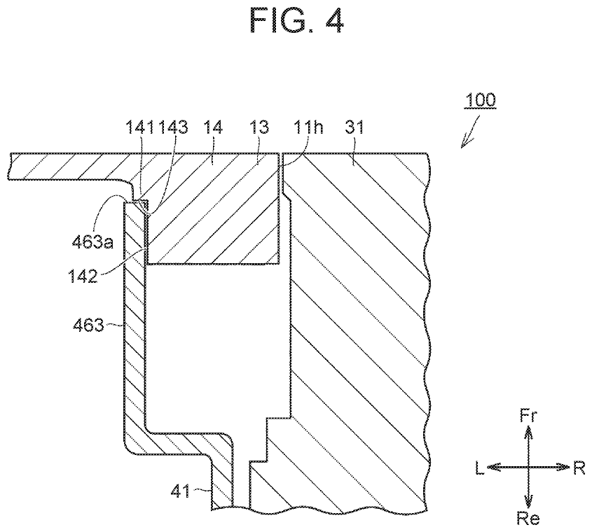

FIG. 4 is a sectional view along line IV-IV indicated in FIG. 1. FIG. 5 is a diagram of the assembled state illustrated in FIG. 1 as viewed from a lateral side. Details of the assembled state will be described with reference to FIGS. 4 and 5.

As illustrated in FIG. 4, each bulge portion 14 includes a side portion 142 extending in the axis direction from the distal end side and a base portion 141 extending outward in the lateral direction on the root side. Consequently, a step portion 143 is formed between the side portion 142 located on the distal end side of the bulge portion 14 and the base portion 141.

In the connector fixing structure 100, an inner surface of the connecting wall portion 463 of each lateral cover portion 46 and the side portion 142 of the corresponding bulge portion 14 are in abutment with each other and a distal end 463a of the connecting wall portion 463 butts the corresponding step portion 143. Consequently, a labyrinth structure is formed between the lateral cover portion 46 and the bulge portion 14. Therefore, in the assembled state, it is possible to curb entry of foreign matter from the outside into the lateral cover portions.

As illustrated in FIG. 5, in the connector fixing structure 100, the upper end 60a side of the leaf spring 60 is in abutment with the end surface 12a of the projection portion 12 (more specifically, the end surfaces 14a of the bulge portions 14). Consequently, the leaf spring 60 connected to the shell 40 can be grounded to the wall portion 11 via the projection portion 12. As a result, an effect of electromagnetic wave noise can be reduced.

Furthermore, on the lower side relative to the lateral cover portions 46, an end surface, in the axis direction, of the shell 40 is retracted relative to the distal ends 463a of the connecting wall portions 463 and a gap is formed between a part of the shell 40, the part being located below the lateral cover portions 46, and the device case 10 (more specifically, the wall portion 11).

Also, the lateral cover portions 46 are at least partly fitted on the respective bulge portions 14. More specifically, the pair of bulge portions 14 are caught between inner surfaces of the pair of lateral cover portions 46. On the other hand, the part of the shell 40, the part being located below the lateral cover portions 46, is not fitted on the device case 10, and on the lower side relative to the lateral cover portions 46, the aforementioned gap is formed between the shell 40 and the device case 10 (more specifically, the wall portion 11).

Because of the gap being formed in this way, even if foreign matter such as liquid enters the shell 40, the foreign matter can be discharged from the gap. As a result, it is possible to curb accumulation of liquid inside the shell 40 and thus it is possible to curb corrosion of the shell 40 and structural objects inside the shell 40.

Here, in the connector fixing structure 100 according to the present embodiment, as described above, the projection portion 12 that projects toward the one side in the axis direction of the attachment hole 11h from the wall portion 11 is provided at the part of the wall portion 11, the part being located around the attachment hole 11h, and the bulge portions 14 are provided as a lateral portion on one end side, in the lateral direction, of the projection portion 12. Furthermore, the shell 40 included in the connector 20 includes the lateral cover portion 46 covering the bulge portions 14.

When the connector 20 is assembled to the device case 10, a worker can easily grasp a position of the connector 20 by bringing the inner surface of one lateral cover portion 46 of the pair of lateral cover portions 46 into abutment with the side portion 142 of the bulge portion 14 corresponding to the one lateral cover portion 46. Therefore, even where the attachment hole 11h cannot be viewed from the front side in relation to surrounding structural objects, the insertion portion 31 of the connector 20 can easily be inserted to the attachment hole 11h. As a result, enhancement of capability of assembling of the connector 20 to the device case 10 can be enabled with such simple configuration. Also, the lateral portions (bulge portions 14) of the projection portion 12 being covered by the lateral cover portions 46 enables curbing entry of foreign matter into the shell 40 from the outside in comparison with a case where the bulge portions 14 are exposed.

In particular, in a case where the device case 10 is disposed on the front side of the vehicle relative to the connector 20 and a worker located on the front side of the device case 10 inserts the insertion portion 31 to the attachment hole 11h from the rear side of the vehicle, the assemblability can favorably be enhanced.

Other Alternations

The above description has been provided taking a case where the projection portion 12 includes the cylindrical portion 13 and the pair of bulge portions 14 disposed on opposite sides, in the lateral direction, of the cylindrical portion 13 as an example; however, the present disclosure is not limited to this example. The bulge portion 14 may be provided on one end side, in the lateral direction, of the cylindrical portion 13 alone. In this case, one of the pair of lateral cover portions 46 covers the bulge portion 14 and the other of the pair of lateral cover portions 46 covers a circumferential wall portion of the cylindrical portion 13. In this case, also, when the connector 20 is assembled to the device case 10, the position of the connector 20 can easily be grasped by bringing the inner surface of the one lateral cover portion 46 into abutment with the side portion 142 of the bulge portion 14, enabling provision of effects that are substantially similar to the effects of the embodiment.

Also, no bulge portions 14 may be provided on the opposite sides of the cylindrical portion 13. In this case, a part, in the lateral direction, of the circumferential wall portion of the cylindrical portion 13 functions as a lateral portion and the lateral cover portions 46 are provided in such a manner as to cover the circumferential wall portion of the cylindrical portion 13 from lateral sides. In this case, also, when the connector 20 is assembled to the device case 10, the position of the connector 20 can easily be grasped by bringing an inner surface of the lateral cover portion 46 into abutment with the circumferential wall portion of the cylindrical portion 13, and thus, it is possible to provide effects that are substantially similar to the effects of the embodiment.

The presently disclosed embodiments are to be considered in all respects only as illustrative and not restrictive. The scope of the present disclosure is, therefore, indicated by the claims and all changes which come within the meaning and range of equivalency of the claims are to be embraced within the scope.

What is claimed is:

1. A connector fixing structure comprising:
a device case including a wall portion in which an attachment hole is provided; and
a connector including
a housing fixed to the device case, the housing including an insertion portion inserted in the attachment hole, and
a shell covering the housing from an outer side, wherein
at a part of the wall portion, the part being located around the attachment hole, a projection portion that projects toward one side in an axis direction of the attachment hole from the wall portion is provided,
the projection portion includes a lateral portion on one end side in a lateral direction orthogonal to the axis direction, and
the shell includes a lateral cover portion that covers the lateral portion.

2. The connector fixing structure according to claim 1, wherein:
the shell includes a body portion including a back-side wall portion located on the one side in the axis direction, an upper wall portion connected to the back-side wall portion on an upper side in a height direction orthogonal to the axis direction and the lateral direction, and a side wall portion connected to the upper wall portion and the back-side wall portion;
the lateral cover portion is provided in such a manner as to project outward in the lateral direction from the side wall portion; and
the lateral cover portion and the body portion are integrally configured using the same member.

3. The connector fixing structure according to claim 1, wherein a labyrinth structure is formed between the lateral portion and the lateral cover portion.

4. The connector fixing structure according to claim 1, wherein the lateral cover portion includes a blocking member that blocks electromagnetic waves or an absorbent member that absorbs electromagnetic waves.

5. The connector fixing structure according to claim 1, wherein a gap is formed between a part of the shell, the part being located below the lateral cover portion in a height direction orthogonal to the axis direction and the lateral direction, and the device case.

6. The connector fixing structure according to claim 1, wherein:
the lateral cover portion is at least partly fitted on the lateral portion; and
a part of the shell, the part being located below the lateral cover portion in a height direction orthogonal to the axis direction and the lateral direction, is not fitted on the device case.

7. The connector fixing structure according to claim 1, wherein:
the lateral cover portion includes a top portion at an upper portion in a height direction orthogonal to the axis direction and the lateral direction; and
the top portion includes an inclined portion inclined downward toward an outer side in the lateral direction.

8. The connector fixing structure according to claim 1, wherein:
the projection portion includes an end surface on the one side in the axis direction;
a leaf spring is connected to the shell; and
the leaf spring is in contact with the end surface of the projection portion.

9. The connector fixing structure according to claim 1, wherein:
the axis direction is parallel to a front-rear direction of a vehicle;
the device case is disposed on a front side of the vehicle relative to the connector; and
the insertion portion is inserted to the attachment hole from a rear side of the vehicle.
